(19) United States
(12) Patent Application Publication
(10) Pub. No.: US 2004/0222613 A1
(43) Pub. Date: Nov. 11, 2004

(54) Motorcycle telescoping highway footpegs

(76) Inventor: Robert Mark Cramer, Bruceton Mills, WV (US)

Correspondence Address: Robert M. Cramer, Rt 5 Box 43H, Bruceton Mills, WV, 26525, US

(21) Appl. No.: 10/431,402

(22) Filed: May 8, 2003

(51) Int. Cl. B62H 1/00

(52) U.S. Cl. 280/291

(57) ABSTRACT

The Telescoping Highway Peg for Motorcycles provides a continuous mechanical appearance that may be placed in the open or closed position without interrupting its horizontal plane. The Telescoping Highway Pegs operate on a telescoping basis with the outer tube sliding over the inner shaft, in comparison to standard application foot pegs in which operate on a swivel joint. The “Key Idea” is the “Telescoping Movement” from the closed to open position.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

The field of endeavor to which the invention pertains is the motorcycle industry. The product can best be described as Telescoping Highway Pegs.

### BRIEF SUMMARY OF THE INVENTION

The Telescoping Highway Peg differs from the standard highway peg in how it retracts into a closed position. Standard pegs flip up while still revealing the entire peg assembly. The Telescoping Pegs slide within one another when closed providing a more compact and neater appearance.

### BRIEF DESCRIPTION OF THE SEVERAL VIEWS OF THE DRAWING

FIG. 1 Depicts the “Inner Shaft” of the Highway Peg

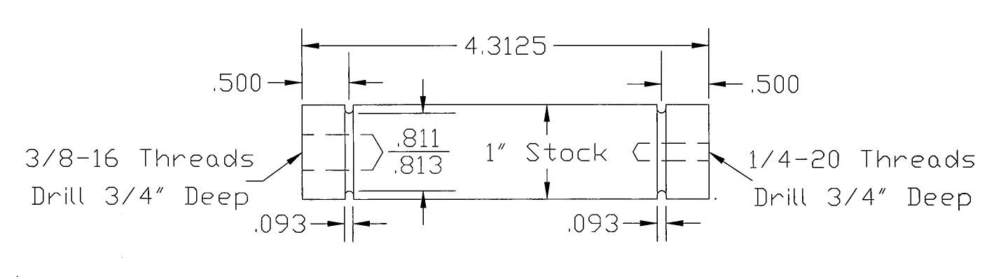

FIG. 2 Depicts the “Outer Tube” of the Highway Peg

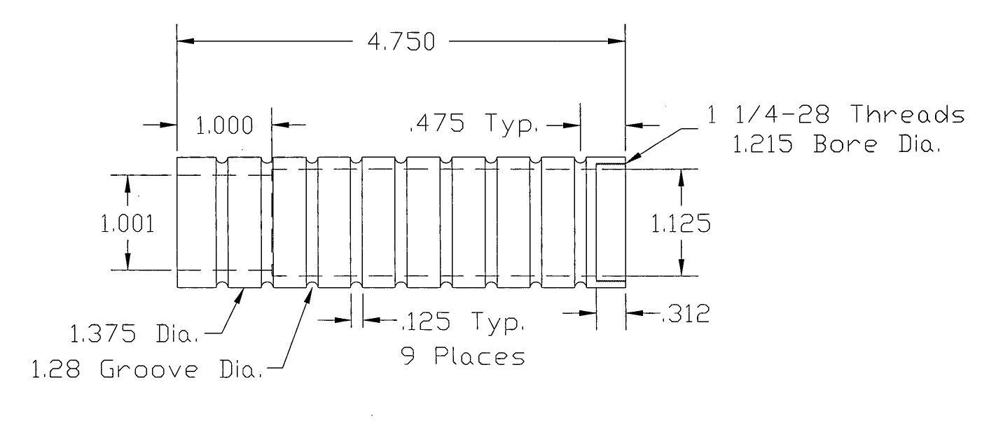

FIG. 3 Depicts the 2 “End Caps” which fasten to the Inner Shaft and Outer Tube,

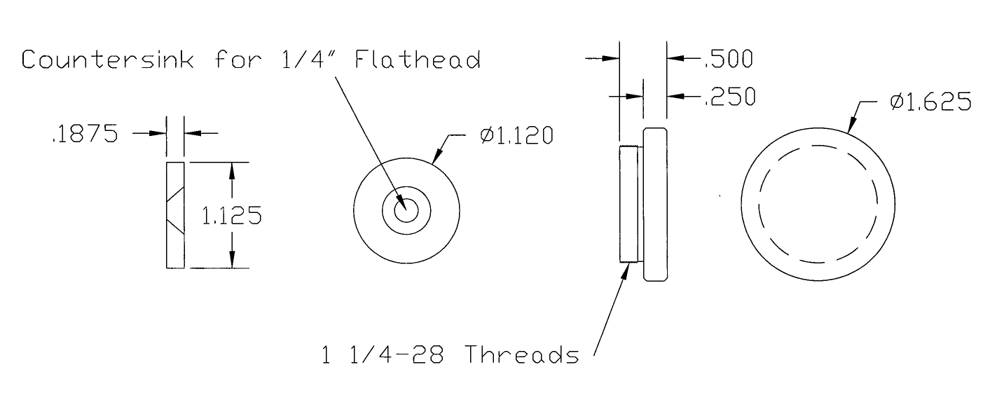

FIG. 4 Depicts the Assembly Drawing of the Closed Version of the Highway Peg

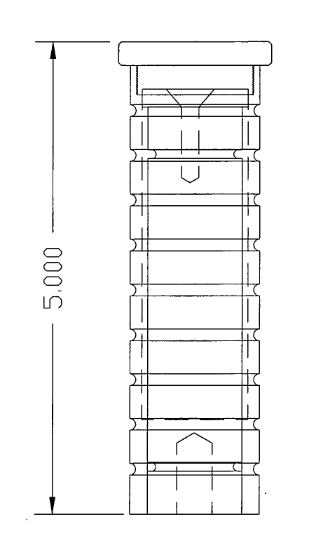

FIG. 5 Depicts the Assembly Drawing of the Extended Version of the Highway Peg

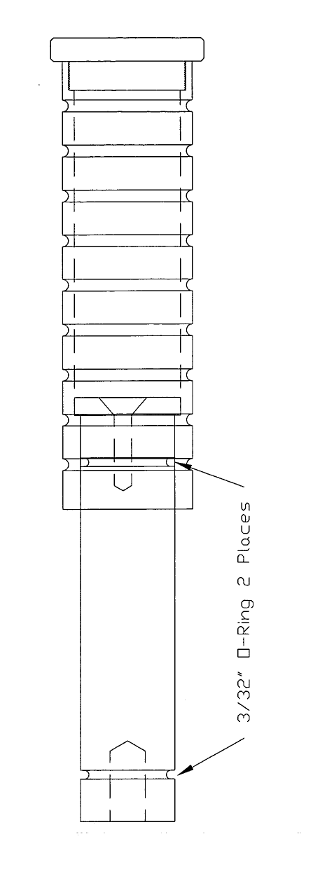

### DETAILED DESCRIPTION OF THE INVENTION

The Telescoping Highway Pegs for motorcycles replaces the old style flip pegs. In the pass, highway pegs basically rotated by a hinge device to a closed or open position. The closed position formed a basic “L” shape. The open position would be in a straight line. The Telescoping Highway Peg remains on the same plane whether it is closed or extended. The Outer Tube slips over the Inner Shaft. The material being used is 304 stainless steel. This will prevent rust from occuring and will enable the sliding action not to be hindered by corrosion. The Outer Tube will be captured by the 1⅛″ retaining cap fastened to the inner shaft using a ¼″ flathead screw. When the pegs are fully extended, the 1⅛″ retaining cap will butt against the 1″ bore section of the Outer Tube. When the pegs are fully closed, the Outer Tube will slide upon the Inner Shaft until butting against the end cap of the Outer Tube.

An O-Ring is used to hold the pegs while they are in both the open and closed positions. O-Ring grooves are machined into the Inner Shaft to allow 0.002-0.004 interference between the bearing surfaces of the Inner shaft and Outer Tube. There will be a 0.002 S.F. between these surfaces. The Inner Shaft will have two O-Ring grooves positions ½″ in from each end to hold the closed and open position of the peg. The Outer Tube is machined with a 0.010 recess in the 1.001 diameter. It is located ½″ in on the 1.001 diameter end. When the pegs are moved into both the open and closed position, the O-Ring will expand into the recess of the Outer Tube to hold each position.

The Inner Cap is fastened onto the Inner Shaft using a ¼-20 Flathead Screw. The Outer Cap is threaded onto the Outer Tube to hold it into place. The outward appearance of the Highway Pegs are machine grooved for a non-slip surface; these recesses can also be fitted with standard O-Rings for an anti-vibration effect. The “Main Advantage or Improvement” of the Telescoping Highway Pegs is the “Neat and Compact” closed position in comparison with traditional pegs. The “Uniform” open position also emphasizes the appearance of one continual part in Comparison to the mechanical function of the traditional pegs.

1. I claim that telescoping highway pegs for motorcycles operate in a telescoping manner with the outer sleeve sliding over the inner shaft in which produces both the open and closed positions of the foot pegs while remaining on the same plane of axis.
